(19) United States
(12) Patent Application Publication
(10) Pub. No.: US 2013/0100775 A1
(43) Pub. Date: Apr. 25, 2013

(54) SYSTEM AND METHOD FOR PROVIDING DISCRETE GROUND CONNECTIONS FOR INDIVIDUAL ELEMENTS IN AN ULTRASONIC ARRAY TRANSDUCER

(71) Applicant: Matthew Todd Spigelmyer, Spring Mills, PA (US)

(72) Inventor: Matthew Todd Spigelmyer, Spring Mills, PA (US)

(21) Appl. No.: 13/281,071

(22) Filed: Oct. 25, 2011

(51) Int. Cl. G01V 1/02; G10K 9/125; H04R 31/00

(52) U.S. Cl. 367/137; 29/25.35; 310/334

(57) ABSTRACT

A system and method for an ultrasonic array transducer is provided. The system includes a plurality of transducer elements, each including a positive electrode and a ground electrode. The system includes a plurality of twisted pair cables. Each twisted pair cable is operatively connected to a respective transducer element by way of a circuit connected therebetween. The circuit includes a plurality of first circuit conductors and a plurality of second circuit conductors. Each first circuit conductor is operatively connected to a respective ground electrode and to a respective twisted pair cable. Each second circuit conductor is operatively connected to a respective positive electrode and to a respective twisted pair cable. The system allows for discrete connections to be made at individual ground electrodes in the transducer array. As a result, appreciable time and labor savings in the process of forming the transducer system can be realized.

### FIELD

Embodiments relate in general to transducers and, more particularly, to ultrasonic array transducers.

### BACKGROUND

Ultrasonic transducers comprise a plurality of individual transducer elements that are used to transmit and receive ultrasonic energy to generate an image of a target. Each transducer element operates as an independent point source. Generally, the greater the quantity of transducer elements, the greater the quality of the image.

Each of these individual elements is electrically connected to a cable, which is, in turn, electrically connected to an ultrasound system. Traditionally, this cable has included a plurality of individual coaxial cables, including one for each transducer array element. The cable has also included a single coaxial cable for a common ground provided for all of the transducer elements. This common ground is formed at the transducer array. However, the use of a common ground results in electrical cross-talk between the individual coaxial cables. Consequently, the ability of each transducer array element to operate independently is limited and performance of the transducer system is reduced.

Thus, there is a need for a system and method that can minimize such concerns.

### SUMMARY

In one respect, embodiments are directed to a transducer system. The system includes a plurality of transducer elements. Each element includes a ground electrode and a positive electrode. Each transducer element can include a piezoelectric base material that is at least partially covered by a plating wrapped around it. Two deactivation cuts can be formed in a surface of the plating. As a result, for each transducer element, a positive electrode is defined by the plating between the deactivation cuts and such that a ground electrode is defined by the plating outside of the two deactivation cuts.

The transducer system can further include a plurality of twisted pair cables. Each twisted pair cable can include a first conductor and a second conductor. The first conductor and the second conductor are twisted about each other along at least a portion of their length. Each twisted pair cable can have an associated twist rate. The twist rate of one or more of the plurality of twisted pair cables can vary over at least a portion of the length of the cable. Any suitable type of twisted pair cables can be used, including, for example, foiled twisted pair cables, shielded twisted pair cables, unshielded twisted pair cables, screened unshielded twisted pair cables, and/or screened shielded twisted pair cables.

Each transducer element is operatively connected to a respective one of the twisted pair cables. The first conductor of each twisted pair cable can be operatively connected to the ground electrode, and the second conductor of each twisted pair cable can be operatively connected to the positive electrode. Thus, discrete connections are made to the ground electrode and the positive electrode of each transducer element.

In one embodiment, the operative connection between a transducer element and a respective one of the twisted pair cables can be indirect. For instance, a circuit can be operatively connected between the transducer elements and the twisted pair cables. In one embodiment, the circuit can be a flexible circuit. The circuit can include a plurality of first conductors and a plurality of second conductors. Each of the plurality of first conductors can be operatively connected to the ground electrode of a respective one of the transducer elements. Further, each of the plurality of second conductors can be operatively connected to the positive electrode of a respective one of the transducer elements.

The transducer system can further include an ultrasound system. Each twisted pair cable can be operatively connected to the ultrasound system.

In another respect, embodiments are directed to an ultrasonic transducer system. The system includes a plurality of transducer elements. Each transducer element includes a piezoelectric base material partially covered by a plating wrapped around the base material. Two substantially parallel deactivation cuts are formed in a surface of the plating such that, for each transducer element, a positive electrode is defined by the plating between the deactivation cuts and such that a ground electrode is defined by the plating material outside of the two deactivation cuts.

The system further includes a circuit. In on embodiment, the circuit can be a flexible circuit. The circuit includes a plurality of first circuit conductors and a plurality of second circuit conductors. A first end portion of each of the plurality of first circuit conductors is operatively connected to the ground electrode of a respective one of the transducer elements. A first end portion of each of the plurality of second circuit conductors is operatively connected to the positive electrode of a respective one of the transducer elements.

The system still further includes a plurality of twisted pair cables. Each twisted pair cable includes a first cable conductor and a second cable conductor. The first and second cable conductors are twisted about each other along at least a portion of their length. A second end portion of each of the plurality of first circuit conductors is operatively connected to a respective one of the first cable conductors. Further, a second end portion of each of the plurality of second circuit conductors is operatively connected to a respective one of the second cable conductors.

In one embodiment, the first circuit conductors can be spaced from the second circuit conductors in a thickness direction of the circuit. Each first circuit conductor can be substantially aligned with a respective one of the second circuit conductors in at least a first end portion of the circuit. Each twisted pair cable can have an associated twist rate. The twist rate of one or more of the plurality of twisted pair cables can vary over at least a portion of the length of the cable.

The system can also include an ultrasound system. In such case, each twisted pair cable can be operatively connected to the ultrasound system.

In a first end portion of the circuit, at least a portion of the first conductors and at least a portion of the second conductors can be exposed outside the circuit. Such exposed portions of the first and second conductors can be on a first side of the circuit for operative connection to respective ground and positive electrodes. A plurality of vias can be provided in the first end portion of the circuit. Each via can extend from a respective one of the second conductors to the first side of the circuit such that a portion of the via or other structure is exposed outside the circuit. Thus, at least a portion of the second conductors can be exposed outside the circuit. In some instances, at least two vias can extend from a respective one of the second conductors to the first side of the circuit such that a portion of the via is exposed outside the circuit. In a second end portion of the circuit, at least a portion of the first conductors and at least a portion of the second conductors can be exposed outside the circuit. Such exposed portions of the first and second conductors can be on a first side of the circuit for operative connection to the first and second conductors of a respective one of the twisted pair cables.

In still another respect, embodiments are directed to a method of forming a transducer assembly. According to the method, an electrode subassembly is provided. The electrode subassembly includes a piezoelectric base that is partially covered by a plating wrapped around the base. Two substantially parallel deactivation cuts are formed in a surface of the plating so as to define a positive electrode between the deactivation cuts and so as to define a ground electrode outside of the two deactivation cuts.

A plurality of elongated cuts is formed in the electrode subassembly. The elongated cuts can extend through the entire thickness of the electrode subassembly. The elongate cuts can extend generally transverse to the deactivation cuts. The elongated cuts can be substantially parallel to each other. In this way, a plurality of transducer elements can be formed. Each transducer element has a ground electrode and a positive electrode.

A plurality of twisted pair cables is provided. Each twisted pair cable includes a first cable conductor and a second cable conductor. The first and second cable conductors are twisted about each other along at least a portion of their length.

Each twisted pair cable can be associated with a respective one of the transducer elements. Each of the plurality of first cable conductors can be operatively connected to the ground electrode of the respective transducer element. Further, each of the plurality of second cable conductors is operatively connected to the positive conductor of the respective transducer element.

In some embodiments, the steps of operatively connecting the first and second cable conductors to the ground and positive electrodes of respective transducer elements can include the step of providing a circuit that includes a plurality of first circuit conductors and a plurality of second circuit conductors. The circuit can be operatively connected between the plurality of twisted pair cables and the plurality of transducers. Thus, each first circuit conductor can indirectly connect one of the first cable conductors to the ground electrode of a respective one of the transducer elements. Further, each second circuit conductor can indirectly connect one of the second cable conductors to the positive electrode of a respective one of the transducer elements.

### BRIEF DESCRIPTION OF THE DRAWINGS

FIG. 1 is a side elevation view of a portion of a transducer system.

FIG. 2 is side elevation view of the transducer system.

FIG. 3 is a cross-sectional view of a cable viewed along line 3-3 in FIG. 2, showing the cable comprising a plurality of twisted pair cables.

FIG. 4 is a view of a circuit, showing a first side of the circuit.

FIG. 5 is a view of the circuit, showing a second side of the circuit.

FIG. 6 is a top plan cross-sectional view of a portion of a first layer of the circuit viewed along line 6-6 in FIG. 1.

FIG. 7 is a top plan cross-sectional view of a portion of a second layer of the circuit, viewed along line 7-7 in FIG. 1.

FIG. 8 is a top plan cross-sectional view of a portion of a first layer of the circuit, showing an arrangement in which vias are provided in pairs.

### DETAILED DESCRIPTION

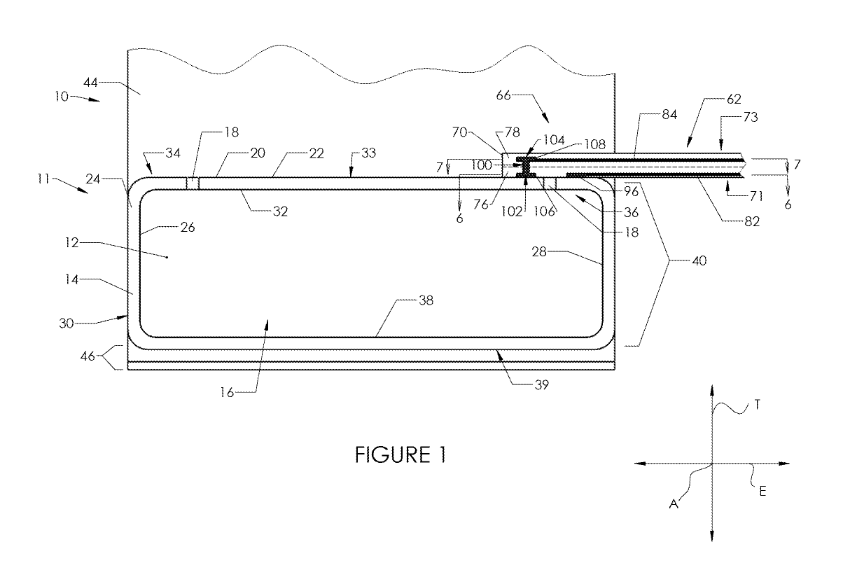

Embodiments are directed to transducer systems and methods. Aspects will be explained in connection with one possible system and method, but the detailed description is intended only as exemplary. Embodiments are shown in FIGS. 1-8, but embodiments are not limited to the illustrated structure or application. It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Transducer systems and methods described herein can provide for discrete ground connections for each individual transducer element in a transducer array. FIG. 1 shows a side elevation view of a portion of a transducer system 10. The transducer system 10 can include a transducer array 11 comprised of a plurality of transducer elements 30 (only one of which is visible in FIG. 1, the other transducer elements 30 being arranged side by side into the page). The transducer array 11 can have an associated elevation direction E, an azimuth direction A that is transverse to the elevation direction E, and a thickness direction T that is transverse to both the elevation direction E and the azimuth direction A. In FIG. 1, the azimuth direction A extends into and out of the page.

The transducer array 11 can have any suitable construction. For instance, the transducer array 11 can include a base material 12. The base material 12 may be provided in the form of a monolithic block. The base material 12 can be a piezoelectric material and, more particularly, a piezoelectric ceramic material. Any suitable piezoelectric ceramic material can be used.

The base material 12 can be partly covered by a plating 14 wrapped or applied therearound. In some instances, the base material 12 can be completed covered by the plating 14. In other instances, a portion of the base material 12 may not be covered. As an example, after the plating 14 is applied around the base material 12, a first azimuth side 16 and an opposite second azimuth side (not shown) of the base material 12 may not be covered by the plating 14. Any suitable material can be used for the plating 14. The plating 14 can be made of a conductive material. In one embodiment, the plating 14 can be made of metal.

Two elongated deactivation cuts 18 are made along a surface 20 of the plating 14 to define a positive electrode 22 and a ground electrode 24. In one embodiment, the deactivation cuts 18 can be substantially parallel to each other. The deactivation cuts 18 can extend generally in the azimuthal direction A. That is, the deactivation cuts 18 extend into and out of the page in FIG. 1. The deactivation cuts 18 can extend proximate to and substantially parallel to the first and second elevation side walls 26, 28 of the base material 12. The deactivation cuts 18 can extend through the entire thickness of the plating 14.

Again, the deactivation cuts 18 can at least partially define the ground electrode 24 and the positive electrode 22 of each transducer element 30 in the transducer system 10. The positive electrode 22 can be formed by the portion of the plating 14 that is disposed between the two deactivation cuts 18. The ground electrode 24 can be formed by the portion of the plating 14 that is disposed outside of the two deactivation cuts 18. Referring to FIG. 1, the ground electrode 24 can extend about a first portion 34 of an upper surface 32 of the base material 12, around the first elevation side wall 26, across a lower surface wall 38 of the base material 12, around the second elevation side wall 28, and about a second portion 36 of the upper surface 32 of the base material 12. The terms “upper” and “lower” are used herein for convenience to facilitate the discussion and are not meant to be limiting. Indeed, the operational position of various side walls and surfaces, including the upper and lower surfaces 32, 38, can vary depending on the application at hand. The base material 12 and the plating 14 with the deactivation cuts 38 can form an electrode subassembly 40. The ground electrode 24 can be electrically isolated from the positive electrode 22.

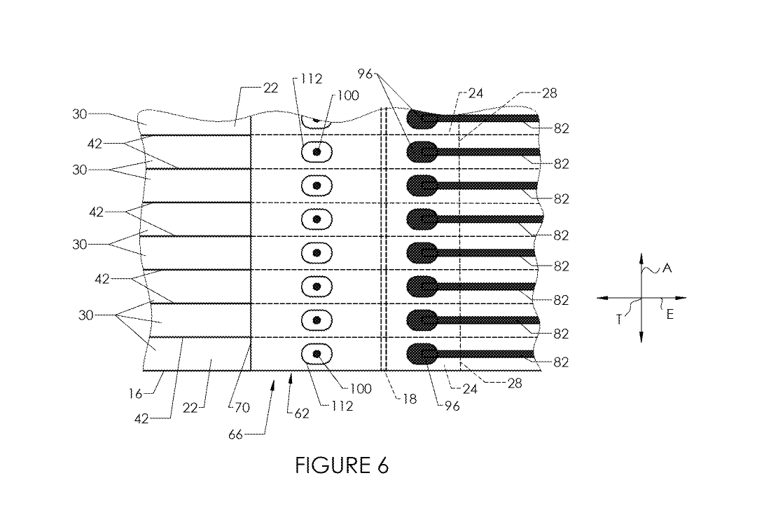

As will be explained in greater detail below, a plurality of transducer elements 30 can be formed by a series of cuts 42 (see FIGS. 6-8) or kerfs made in the electrode subassembly 40. The cuts 42 can extend generally in the elevation direction E, generally transverse to the deactivation cuts 18. For instance, the cuts 42 can extend at substantially 90 degrees to the deactivation cuts 18. The cuts 42 can extend through the entire thickness of the electrode subassembly 40. These cuts 42 can be formed by a dicing saw or other suitable device. The resultant cuts 42 can define at least in part the individual transducer elements 30 of the transducer assembly 10. The cuts 42 can be substantially equally spaced apart. The cuts 42 can be substantially parallel to each other.

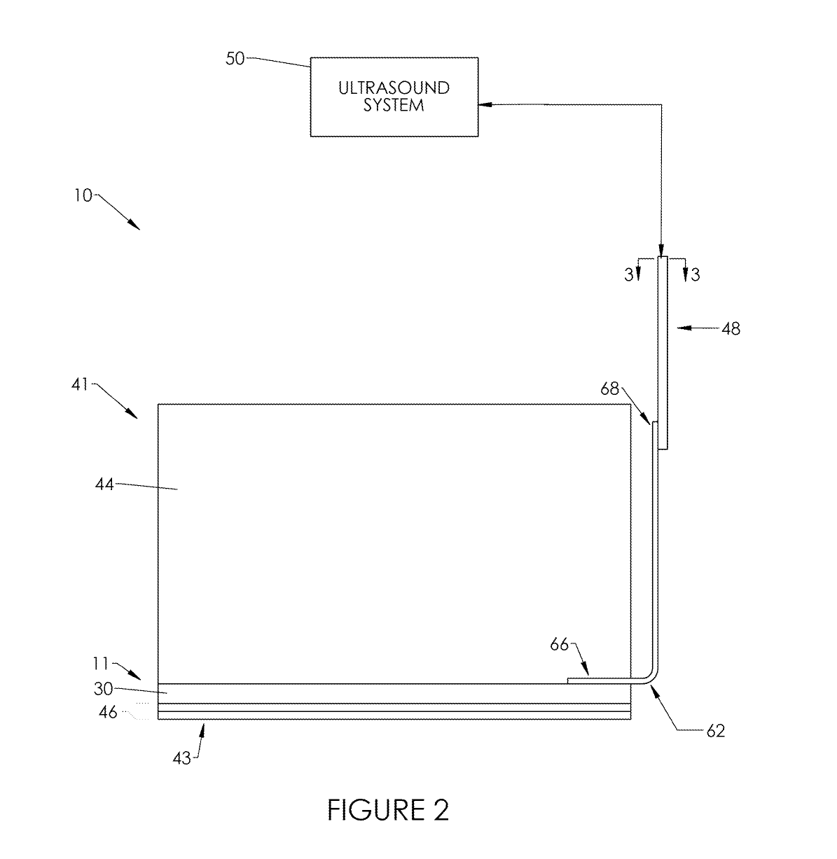

A solid backer 44 may be attached to at least a portion of an upper surface 33 of the electrode subassembly 40, as is shown in FIGS. 1-2. Such attachment can be achieved in any suitable manner, including, for example, by the use of a suitable adhesive or bonding material, such as an epoxy. The backer 44 can be made of any suitable material. The backer 44 can provide structural integrity to the transducer array 11.

One or more matching layers 46 can be attached to a lower surface 39 (FIG. 1) of the electrode subassembly 40. Such attachment can be achieved in any suitable manner, including, for example, by the use of a suitable adhesive or bonding material, such as an epoxy. The one or more matching layers 46 can minimize acoustic mismatches between the transducer elements 30, which typically have very large acoustic impedance, and the body of a patient being imaged, which has low acoustic impedance. As a result, the matching layers 46 can improve acoustic energy transmission efficiency. FIGS. 1 and 2 show an example in which a plurality of matching layers 46 is provided.

According to embodiments herein, discrete connections are made to the ground electrode 24 and the positive electrode 22 for each transducer element 30, thereby avoiding the need to provide a common ground at the transducer system 10 and/or transducer array 11, as has been done in the past. Referring to FIG. 2, the ground electrode 24 and the positive electrode 22 for each transducer element 30 can be operatively connected to a signal carrying device 48, which, in turn can be operatively connected to carry electrical signals to an ultrasound system 50. The term “operatively connected,” as used throughout this description, can include direct or indirect connections, including connections without direct physical contact.

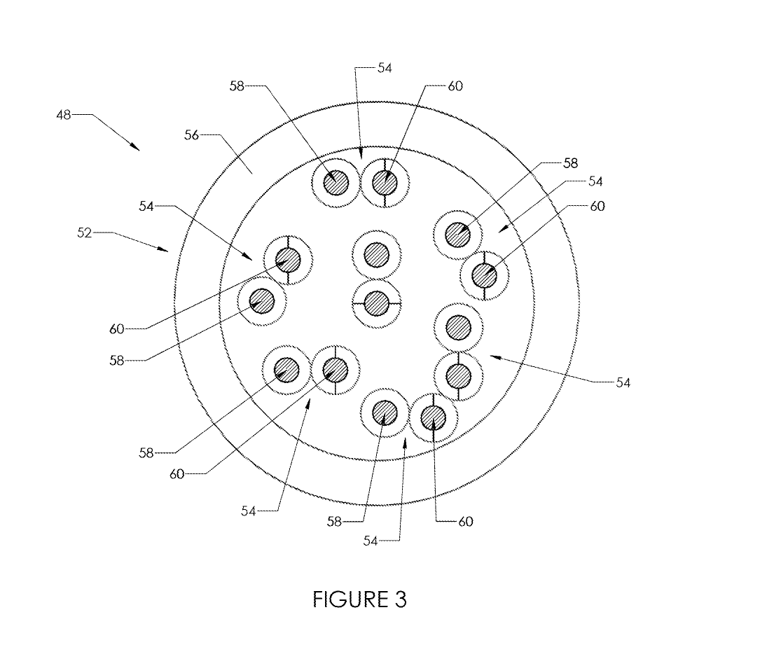

The signal carrying device 48 can be any suitable structure. In one embodiment, the signal carrying device 48 can be a cable 52 (FIG. 3) that comprises a plurality of twisted pair cables 54. FIG. 3 shows a cross-sectional view of the cable 52, viewed along line 3-3 in FIG. 2. The plurality of twisted pair cables 54 can be enclosed within an outer sheath 56 or other suitable enclosure. While FIG. 3 shows there being seven twisted pair cables 54, it will be understood that there can be any quantity of twisted pair cables 54. Indeed, one twisted pair cable 54 can be provided for each transducer element 30.

Each twisted pair cable 54 can comprise two conductors—a first conductor 58 and a second conductor 60—that are twisted together along their length. In each twisted pair cable 54, the first conductor 58 can be provided for operative connection to the ground electrode 24 of a transducer element 30, and the second conductor 60 can be provided for operative connection to the positive electrode 22 of the same transducer element 30. The first and second conductors 58, 60 can be made of any suitable material. The first conductors 58 can be substantially identical to the second conductors 60. Alternatively, the second conductors 60 can be different from the first conductors 58 in one or more respects. The first and second conductors 58, 60 can have any suitable size and cross-sectional shape.

The twisted pair cables 54 can be provided in any suitable form. For instance, the twisted pair cables 54 can be foiled twisted pair (FTP), shielded twisted pair (STP or STP-A), unshielded twisted pair (UTP), screened unshielded twisted pair (S/UTP), or screened shielded twisted pair (S/STP or S/FTP) cables. The plurality of twisted pair cables 54 can be one of these types, some other type, and/or combinations thereof.

The first and second conductors 58, 60 of each twisted pair cable 54 can be twisted together in any suitable manner. Each twisted pair cable 54 can have an associated twist rate, that is, the number of twists per unit length. The twisted pair cables 54 can have any suitable twist rate. In one embodiment, the twist rate can be substantially constant along the length of the twisted pair cable 54. Alternatively, the twist rate can vary along at least a portion of the length of the twisted pair cable 54. The twist rate can be selected to achieve the desired properties. The plurality of twisted pair cables 54 can be substantially identical to each other, or one or more of the twisted pair cables 54 can be different from the other twisted pair cables 54 in one or more respects, including, for example, in the associated twist rate.

The operative connection between the signal carrying device 48 and the individual transducer elements 30 can be achieved in any suitable manner. For instance, the operative connection can include direct connections and indirect connections. As an example of a direct operative connection, end portions of each twisted pair cable 54 can be attached directly to the positive electrode 22 and the ground electrode 24 of a respective one of the transducer elements 30 (not shown). Such direct attachment can be achieved in any suitable manner.

One example of an indirect operative connection between the transducer elements 30 and the signal carrying device 48 is shown in FIG. 2. In particular, there can be a circuit 62 or other suitable structure operatively positioned between the transducer elements 30 and the signal carrying device 48.

In such case, a first end portion 66 of the circuit 62 can be operatively connected to the electrode subassembly 40. The first end portion 66 can be sandwiched between the backer 44 and the transducer elements 30. As will be explained later in greater detail below, electrical connections can be made between the circuit 62 and the positive and ground electrodes 22, 24 of each transducer element 30. A second end portion 68 of the circuit 62 can be operatively connected to the signal carrying device 48.

It should be noted that FIG. 2 shows the circuit 62 as being operatively connected to one portion of the transducer array 11 and/or electrode subassembly 40 (the right side portion as shown in FIG. 2), but it will be appreciated that embodiments are not limited to such an arrangement. Indeed, alternatively or in addition, the circuit 62 can be operatively connected to a different portion of the electrode subassembly 40. In some instances, there can be more than one circuit 62 operatively connected to the electrode subassembly 40. For example, another circuit (not shown) can be provided on the left side portion of the transducer array 11 and/or electrode subassembly 40 in FIG. 2. Further, the circuit 62 is shown as being operatively connected to the non-patient side 41 of the transducer array 11 and/or electrode subassembly 40, that is, from the side of the array 11 and/or electrode subassembly 40 to which the backer 44 is attached. However, it will be appreciated that, in some embodiments, the circuit 62 can be operatively connected to the patient side 43 of the transducer array 11 and/or electrode subassembly 40, that is, from the side of the transducer array 11 and/or electrode subassembly 40 to which the matching layer 46 is attached.

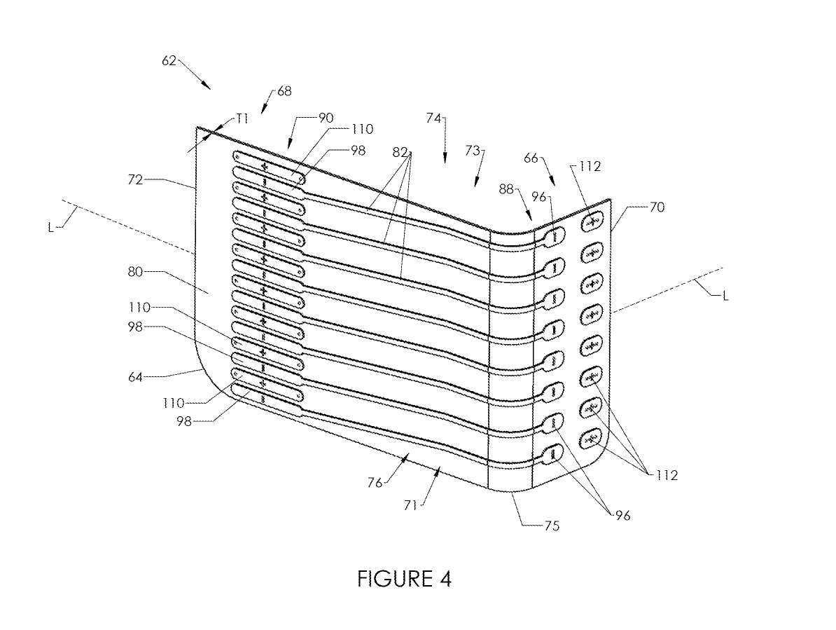

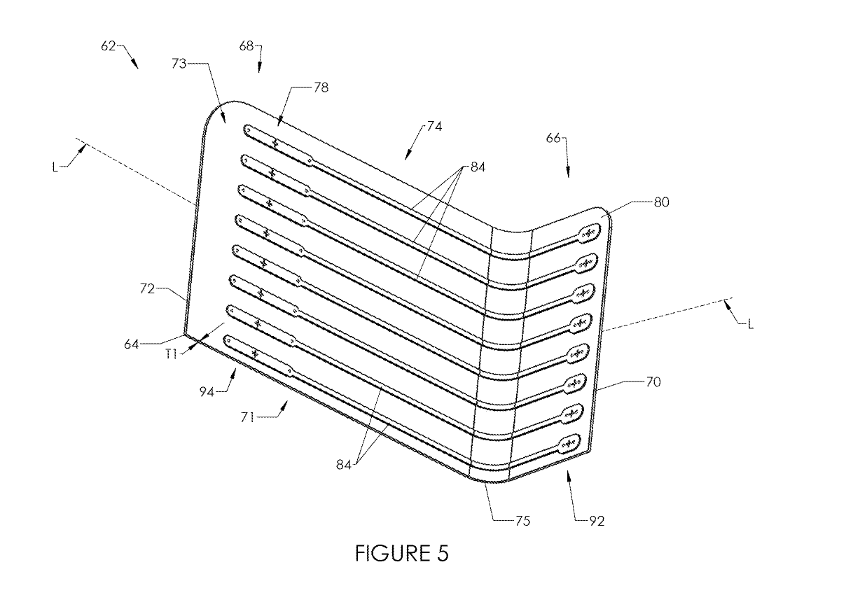

In one embodiment, the circuit 62 can be a flexible circuit. An example of a suitable flexible circuit 64 is shown in FIGS. 4-5. The circuit 62 can have an associated longitudinal axis L. The longitudinal axis L may or may not be straight. The circuit 62 can have an associated thickness T1. The circuit 62 can have any suitable shape. In one embodiment, the circuit 62 can be generally L-shaped, as is shown in FIG. 4. In the case of a flexible circuit 64, the circuit 62 can have any suitable shape. The circuit 62 can have a first end portion 66 including a first end 70 and a second end portion 68 including a second end 72. The circuit 62 can have a middle portion 74 between the first and second end portions 66, 68. The circuit 62 can have a first side 71 and a second side 73.

The circuit 62 can include a plurality of first conductors 82 (FIG. 4) and a plurality of second conductors 84 (FIG. 5). The first and second conductors 82, 84 can generally extend in the direction of the longitudinal axis L of the circuit 62. Each of the plurality of first conductors 82 can be provided for operative connection to the ground electrodes 24 of a respective one of the transducer elements 30. Each of the plurality of second conductors 84 can be provided for operative connection to the positive electrodes 22 of a respective one of the transducer elements 30. The plurality of first conductors 82 can be electrically isolated from each other. The plurality of second conductors 84 can be electrically isolated from each other. Further, the first conductors 82 can be electrically isolated from the second conductors 84.

The first conductors 82 and the second conductors 82 can be arranged in any suitable manner. For example, in some embodiments, the circuit 62 can have at least two layers. The layers may include one or more curves, bends or other non-planar feature. As an example, the layers in the circuit 62 shown in FIG. 4 include a bend 75. Each layer can be separated by an insulating layer or substrate. As will be described below, there can be communication between the layers in at least some places.

The circuit 62 can include a first layer 76 (FIG. 4) and a second layer 78 (FIG. 5). The first and second layers 76, 78 can be separated by an insulating material 80 so as to electrically isolate the first and second layers 76, 78. The first layer 76 can include a plurality of first conductors 82. The first conductors 82 can be made of any suitable conductive material. In some instances, the first conductors 82 can be at least partially covered by and/or embedded in insulating material, as is shown in FIG. 1. However, in other instances, the first conductors 82 may not be covered by insulating material, as is shown in FIGS. 4. In such case, the first conductors 82 may be exposed outside the circuit 62 along at least a portion of their length. In one embodiment, the first conductors 82 can be exposed along their entire length on the first side 71 of the circuit 62.

In one embodiment, the first layer 76 can at least partially define the first side 71 of the circuit 62. Each of the first conductors 82 can have a proximal end 88 and a distal end 90, as is shown in FIG. 4. The terms “proximal” and “distal” are used herein for convenience to indicate the relative location of the ends to the transducer elements 30. The first conductors 82 can extend substantially straight in the first layer 76. Alternatively, one or more of the first conductors 82 can include one or more non-straight features, such as a bend, curve, angle or jog. The first conductors 82 can be substantially parallel to each other, or one or more of the first conductors 82 can be non-parallel to the other first conductors 82. The first conductors 82 can be substantially identical to each other, or at least one of the first conductors 82 can be different from the other first conductors 82 in one or more respects.

Similarly, the second layer 78 can include a plurality of second conductors 84. The second conductors 84 can be made of any suitable conductive material. In some instances, the second conductors 84 can be at least partially covered by and/or embedded in insulating material, as is shown in FIG. 1. However, in other instances, the second conductors 84 may not be covered by insulating material, as is shown in FIGS. 5. In such case, the second conductors 84 may be exposed outside the circuit 62 along at least a portion of their length. In one embodiment, the second conductors 84 can be exposed along their entire length on the second side 73 of the circuit 62.

In one embodiment, the second layer 78 can at least partially define the second side 73 of the circuit 62. Each of the second conductors 84 can have a proximal end 92 and a distal end 94, as is shown in FIG. 5. The second conductors 84 can extend substantially straight in the second layer 78. Alternatively, one or more of the second conductors 84 can include one or more non-straight features, such as a bend, curve, angle or jog. The second conductors 84 can be substantially parallel to each other, or one or more of the second conductors 84 can be non-parallel to the other second conductors 84. The second conductors 84 can be substantially identical to each other, or at least one of the second conductors 84 can be different from the other second conductors 84 in one or more respects.

In the transducer system 10, a portion of the circuit 62, such as a portion of the first layer 76, can be substantially adjacent to the positive electrode 40 and the ground electrode 42 on the upper surface 33 of the electrode subassembly 40. “Substantially adjacent” means direct physical abutment or a slight spacing therebetween in at least some places.

FIG. 6 is a top plan cross-sectional view of the first layer 76 of the circuit 62, as viewed in the direction of the arrows associated with line 6-6 in FIG. 1. None of the deactivation cuts 18 would be seen in this view, but one is shown in dashed lines for reference. Likewise, none of the transducer elements 30 would be seen in this view because they would be covered by the backer 44 and/or the circuit 62. However, the backer 44 has been removed from this view for clarity. At least a portion of the first conductors 82 can be exposed outside the circuit 62, such as in the first end portion 66 thereof, for connection to a respective ground electrode 24 of one of the transducer elements 30. The plurality of first conductors 82 can be adapted to facilitate the operative connection to another item, such as the ground electrodes 24. For example, the proximal end 88 of the first conductors 82 can include connection pads 96 (see FIGS. 4 and 6) or other suitable structure.

The first conductors 82 can extend from their proximal ends 88 to their distal ends 90. In one embodiment, the first conductors 82 can extend entirely within the first layer 76 and/or entirely on the first side 71 of the circuit 62, as is shown in FIGS. 4-5. At least a portion of the first conductors 82 can be exposed outside the circuit 62 for connection to another item, such as the signal carrying device 48 or, more particularly, one of the first conductors 58 of a respective one of the twisted pair cables 54. The plurality first conductors 82 can be adapted to facilitate operative connection to the twisted pair cables 54. For example, the distal end 90 of the first conductors 82 can include connection pads 98 (see FIG. 4) or other suitable structure. The connection pads 98 can be substantially identical to the connection pad 96 at the proximal ends 88 of the first conductors 88. Alternatively, the connection pads 98 can be different from the connection pad 96 at the proximal ends 88 of the first conductors 88 in one or more respects. For example, as shown in FIG. 4, the connection pads 98 can be longer in the direction of the longitudinal axis L than the connection pads 96. Alternatively or in addition, the connection pads 98 may be narrower than the connection pads 96 in a direction that is transverse to the longitudinal axis L.

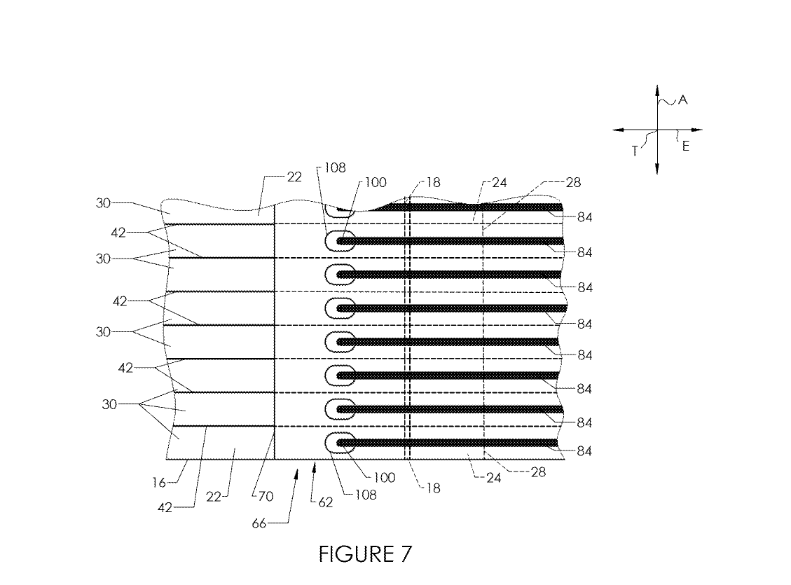

FIG. 7 is a top plan cross-sectional view of the second layer 76 the circuit 62, as viewed in the direction of the arrows associated with line 7-7 in FIG. 1. None of the deactivation cut 18 would be seen in this view, but one is shown in dashed lines for reference. Likewise, none of the transducer elements 30 would be seen in this view because they would be covered by the backer 44 and/or the circuit 62. However, the backer 44 has been removed from this view for clarity. At least a portion of the second conductors 84 can be exposed outside the circuit 62, such as in the first end portion 66 thereof, for connection to another item, such as a respective positive electrode 22 of one of the transducer elements 30. The plurality second conductors 84 can be adapted to facilitate operative connection to the positive electrodes 22, as will be described in greater detail below.

The second conductors 84 can extend at least partially within the second layer 78 of the circuit 62. In one embodiment, a portion of the second conductors 84 can be exposed outside the circuit 62 on the same side of the circuit 62 as the first conductors 82, such as one the first side 71 of the circuit 62 as is shown in FIGS. 1 and 4. Such an arrangement can be advantageous since, in some instances, the positive and ground electrodes 22, 24 can be provided on the same side of each transducer element 30. Such an arrangement can be achieved in any suitable manner. For example, a plurality of vias 100 (FIG. 1) can extend within at least a portion of the circuit 62. The term “via” means any suitable element for establishing electrical connection between conductors in different layers within the circuit and/or with one or more conductors external to the circuit. Any suitable type of via can be used. In one embodiment, the vias can be pads with plated holes, which can be made to be conductive by electroplating, or the holes can be filled with annular rings or rivets. Embodiments are not limited to any particular type of via.

The vias 100 can be associated with the second conductors 84. One or more vias 100 can be associated with each of the second conductors 84. The quantity of vias 100 associated with each second conductor 84 can be identical, or there can be a different quantity of vias 100 associated with one or more of the second conductors 84. One or more of the vias 100 can extend generally in the thickness direction T1 (FIGS. 4-5) of the circuit 62, or one or more of the vias 100 can extend at an angle relative to the thickness direction T1. The vias 100 can be substantially straight, or at least one of the vias 100 can include one or more non-straight features along its length.

Each of the plurality of vias 100 can have a first end 102 and a second end 104, as is shown in FIG. 1. The first end 102 of each of the vias 100 can be exposed outside the circuit 62 for connection to an item, such as a respective positive electrode 22 of one of the transducer elements 30. The first end 102 of the vias 100 can be adapted to facilitate operative connection to the positive electrodes 22. For example, the first end 102 of one or more of the vias 100 can include a connection pad 106 (see FIG. 1). The second end 104 of the vias 100 can terminate within or external to the second layer 78. The second end 104 of one or more of the vias 100 can include a connection pad 108 (see FIG. 1) and/or other features to facilitate operative connection to another item. A respective one of the second conductors 84 can be operatively connected to the second end 104 of each via 100.

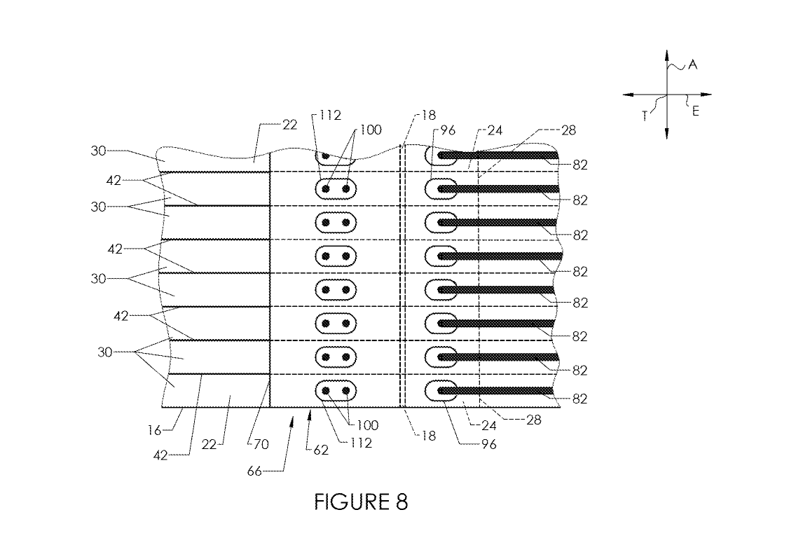

It may be beneficial to configure the vias to minimize problems that would be caused if one or more of the vias 100 were to break or malfunction. For example, redundancy can be introduced into the system so that additional vias are provided in at least some locations. To that end, at least some of the vias 100 can be provided in pairs or in triplets. An example of an arrangement in which pairs of vias are provided is shown in FIG. 8. Naturally, pairs of vias can be provided at the second end portion 68 of the circuit 62 as well. In some instances, vias 100 may not be used.

The second conductors 84 can extend from their proximal end 92 to their distal ends 94, as is shown in FIG. 5. The second conductors 84 can extend substantially entirely within the second layer 76. Alternatively or in addition, the second conductors 84 can extend substantially or entirely on the second side 73 of the circuit 62, as is shown in FIGS. 4-5. At least a portion of the second conductors 84 can be exposed outside the circuit 62 for connection to another item, such as a conductor of a respective one of the twisted pair cables 54. The plurality second conductors 84 can be adapted to facilitate operative connection to the twisted pair cables 54 or other signal carrying device 48. For example, the distal end 94 of the second conductors 84 can include connection pads 110 (see FIG. 4) or other suitable structure. The connection pads 110 can be substantially identical to the connection pads 112 at the proximal ends 92 of the second conductors 84. Alternatively, the connection pads 110 can be different from the connection pads 112 at the proximal ends 92 of the second conductors 84 in one or more respects, as shown in FIG. 4.

In one embodiment, at least a portion of the connection pads 110 of the second conductors 84 can be provided on the same side of the circuit 62 as the connection pads 96 for the first conductors 82, as is shown in FIG. 4. Such an arrangement can facilitate connection to the signal carrying device 48. In such case, the connection pads 98 of the first conductors 82 and the connection pads 110 of the second conductors 84 can be generally side by side, as is shown in FIG. 4. In such case, the connection pads 98 and the connections pads 110 can be spaced apart in the in a direction transverse to the longitudinal axis L of the circuit 62. The connection pads 98 and the connections pads 110 can alternate with each other. It should be noted that in arrangements in which the connection pads 98, 110 are provided on the same side of the circuit 62, it may be necessary to provide vias (not shown) to extend from the second layer 78 to the first layer 76 of the circuit 62 between each second conductor 84 and the respective connection pad 110. To that end the above discussion of the vias 100 applies equally here.

It should also be noted that the circuit 62 shown in FIGS. 1 and 4-8 is merely one example of a suitable circuit, and that other arrangements of the circuit 62 are possible. For instance, the positions of the first and second conductors 82, 84 can be switched such that the first conductors 82 extend in the second layer 78 and the second conductors 84 can extend in the first layer 76. In addition, while the above description and the associated drawings show the vias 100 being associated with the second conductors 84, it will be understood that vias 100 may also be provided with the first conductors 82.

For the circuit 62 shown in FIGS. 4-5, it is noted that, in at least the first end portion 66 of the circuit 62, the first and second conductors 82, 84 for each transducer element 30 can extend in substantial alignment along the circuit 62 though on opposite sides 71, 73 of the circuit 62. Such an arrangement can be beneficial because when the circuit 62 is cut during the assembly process, as will be described below, there is sufficient space between neighboring conductors to minimize the possibility of severing the conductors. Such alignment of the first and second conductors 82, 84 can continue for any suitable distance along the circuit 62 and may even continue to the distal ends 90, 94 of the first and second conductors 82, 84. However, in one embodiment, there can be a jog portion of one of the conductors so as to achieve the arrangement in which the connection pads 98, 110 of the first and second conductors 82, 84 are provided side by side as discussed above. For instance, FIG. 4 shows an example in which the first conductors 82 extend diagonally in the first layer 76. However, it will be understood that such an arrangement is only one way in which a side-by-side arrangement of the connection pads 98, 110 can be achieved.

Now that the details of the circuit have been described, one method of assembling a transducer system described herein will now be described, but it is understood that the method can be carried out with other suitable systems and arrangements. It will be understood that the following description is provided as only an example, and embodiments are not limited to any particular method of assembly. Moreover, the method may include other steps that are not described herein, and in fact, the method is not limited to including every step that is described herein. Additionally, the steps described herein are not limited to this particular chronological order, either. Indeed, some of the steps may be performed in a different order than what is described and/or at least some of the steps can occur simultaneously.

The electrode subassembly 40 can be formed in any suitable manner, including in any conventional manner. Likewise, one or more matching layers 46 (FIGS. 1-2) can be attached to the lower side 39 of the electrode subassembly 40 in any suitable manner. A portion of the circuit 62 (i.e., the first end portion 66) and the upper side 33 of the electrode subassembly 40 can be brought into engagement with each other. The circuit 62 and/or the electrode subassembly 40 can be positioned such that the exposed portion of the first conductors 82 (i.e., the connection pads 96) can be located outboard of the deactivation cuts 18 (see FIG. 6) so as to be aligned with the ground electrode 24. At this stage in the process, there is only a single electrode. An exposed portion of the second conductors 84 (i.e., the connection pads 112) can be located inboard of the deactivation cuts 18 (see FIG. 6) so as to be aligned with the positive electrode 22. There is only a single positive electrode at this stage of the process.

The proximal end 88 of each first conductor 82 of the circuit 62 can be operatively connected to the ground electrode 24 in any suitable manner. For instance, the connection pad 96 of each first conductor 82 can be operatively connected to the ground electrode 24 by epoxy or other suitable adhesive and/or by physical engagement between the connection pad 96 and the ground electrode 24. Likewise, the proximal end 92 of each second conductor 84 of the circuit 62 can be operatively connected to the positive electrode 22 of the in any suitable manner, including as described above. In one embodiment, the first end 102 of each via 100 can be operatively connected to the positive electrode 22. A backer 44 can be attached to the electrode subassembly 40 such that the circuit 62 is sandwiched between the backer 44 and the electrode subassembly 40. The backer 44 can provide structural integrity to the transducer assembly 32.

The plurality of individual transducer elements 30 can be formed by making a plurality of parallel dices or cuts 42 (see FIGS. 6-8) in the assembly. Such cuts 42 can be formed using a dicing saw (not shown) or other suitable cutting device. The dicing saw can be brought into contact with the assembly from the patient side 43 (FIG. 2) of the assembly, that is, from the matching layer 46 side of the assembly. Thus, the dicing saw can cut through the one or more matching layers 46, through the plating 14 and through the base material 12. The dicing saw may also cut through at least a portion of the circuit 62. In one embodiment, the dicing saw may cut through the entire circuit 62 and into a portion of the backer 44. A plurality of transducer elements 30 are formed by the dicing operation. The cuts 42 formed by the dicing saw can extend in a direction that is generally transverse to the direction in which the deactivation cuts 18 extend. In one embodiment, the cuts 42 can extend in a direction that is substantially perpendicular to the deactivation cuts 18.

As described above, the first conductors 82 can be substantially aligned with the second conductors 84 in the thickness T1 of the circuit 62, at least in the first end portion 66 of the circuit 62. As a result, the cuts 42 can be made into the circuit 62 between the aligned pairs of first and second conductors 82, 84 so as not to cut, damage or otherwise interfere with the functionality of the conductors 82, 84.

The undiced portion of the backer 44 can hold the diced assembly together. After the dicing operation, kerf filler (not shown) can be placed in the space formed by the cuts 42 to provide structural support to the diced assembly. The kerf filler can also provide some degree of acoustic isolation between the transducer elements.

A signal carrying device 48, such as a cable 52 including a plurality of twisted pair cables 54, can be operatively connected to the second end portion 68 of the circuit 62. More particularly, for each transducer element 30, the first conductor 58 of a respective one of the twisted cables 54 can be operatively connected to a portion of one of the first conductors 82 of the circuit 62, such as the connection pad 98. The second conductor 60 of the same twisted pair cable 54 can be operatively connected a portion of one of the second conductors 84 of the circuit 62, such as the connection pad 110. Such operative connections can be made in any suitable manner. These steps can be repeated for each transducer element 30 in the transducer array 11. The other ends of the first and second conductors 58, 60 of the twisted pair cables 54 can be operatively connected to the ultrasound system 50 in any suitable manner. The transducer system 10 can then be used in any known manner.

It will be appreciated that systems and methods described herein can provide significant advantages. For instance, because discrete ground electrodes 24 are maintained in the transducer system 10, there is no need to form a common ground electrode, as has been done in the past. As a result, appreciable time and labor savings in the process of forming the transducer system can be realized. Further, the use of individual ground traces can help to minimize electrical cross-talk. Twisted pair cables have demonstrated to have performance characteristics comparable to coaxial cables in this context. Additionally, these performance enhancements can be achieved without increasing the cost of the system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Examples have been described above regarding a transducer assembly and method of manufacturing the same. However, it will be understood that embodiments herein can be implemented in other systems or apparatus in which it is desired to provide discrete ground connections instead of a common ground. Thus, it will of course be understood that embodiments are not limited to the specific details described here, which are given by way of example only, and that various modifications and alterations are possible within the scope of the following claims.

What is claimed is:

1. A transducer system comprising:
a plurality of transducer elements, each element including a ground electrode and a positive electrode; and
a plurality of twisted pair cables, each twisted pair cable including a first conductor and a second conductor twisted about each other along at least a portion of their length, each element being operatively connected to an end of a respective one of the twisted par cables such that the first conductor is operatively connected to the ground electrode and the second conductor is operatively connected to the positive electrode, whereby discrete connections are made to the ground electrode and the positive electrode of each transducer element.

2. The system of claim 1 wherein each transducer element includes a piezoelectric base material partially covered by a plating wrapped therearound, wherein two deactivation cuts are formed in a surface of the plating so as to define the positive electrode between the deactivation cuts and the ground electrode outside of the two deactivation cuts for each transducer element.

3. The system of claim 1 wherein the operative connection between a transducer element and a respective one of the twisted pair cables is indirect.

4. The system of claim 3 further including a circuit operatively connected between the transducer elements and the twisted pair cables.

5. The system of claim 4 wherein the circuit is a flexible circuit.

6. The system of claim 4 wherein the circuit includes a plurality of first conductors and a plurality of second conductors, wherein each of the plurality of first conductors is operatively connected to the ground electrode of a respective one of the transducer elements, and wherein each of the plurality of second conductors is operatively connected to the positive electrode of a respective one of the transducer elements.

7. The system of claim 1 further including an ultrasound system, wherein each twisted pair cable is operatively connected to the ultrasound system.

8. The system of claim 1 wherein each twisted pair cable has an associated twist rate, wherein the twist rate of at least one of the plurality of twisted pair cables varies over at least a portion of the length of the cable.

9. The system of claim 1, where the twisted pair cables are foiled twisted pair cables, shielded twisted pair cables, unshielded twisted pair cables, screened unshielded twisted pair cables, or screened shielded twisted pair cables.

10. An ultrasonic transducer system comprising:
a plurality of transducer elements, each transducer element includes a piezoelectric base material partially covered by a plating wrapped therearound, wherein two substantially parallel deactivation cuts are formed in a surface of the plating so as to define a positive electrode between the deactivation cuts and a ground electrode outside of the two deactivation cuts for each transducer element;
a circuit including a plurality of first circuit conductors and a plurality of second circuit conductors, a first end of each of the plurality of first circuit conductors is operatively connected to the ground electrode of a respective transducer element, and a first end of each of the plurality of second circuit conductors is operatively connected to the positive electrode of a respective transducer element; and
a plurality of twisted pair cables, each twisted pair cable including a first cable conductor and a second cable conductor twisted about each other along at least a portion of their length, a second end of each of the plurality of first circuit conductors being operatively connected to an end of a respective one of the first cable conductors, and a second end of each of the plurality of second circuit conductors being operatively connected to an end of a respective one of the second cable conductors.

11. The system of claim 10, wherein the circuit is a flexible circuit.

12. The system of claim 10, further including an ultrasound system, wherein another end of each twisted pair cable is operatively connected to the ultrasound system.

13. The system of claim 10, wherein each twisted pair cable has an associated twist rate, wherein the twist rate of at least one of the plurality of twisted pair cables varies over at least a portion of the length of the cable.

14. The system of claim 10, wherein, in a first end portion of the circuit, at least a portion of the first conductors and at least a portion of the second conductors are exposed outside the circuit on a first side of the circuit for operative connection to respective ground and positive electrodes.

15. The system of claim 14, further including a plurality of vias in the first end portion of the circuit, each via extending from a respective one of the second conductors to the first side of the circuit such that a portion of the via is exposed outside the circuit, whereby at least a portion of the second conductors is exposed outside the circuit.

16. The system of claim 15, wherein at least two vias extending from a respective one of the second conductors to the first side of the circuit such that a portion of the via is exposed outside the circuit.

17. The system of claim 10, wherein, in a second end portion of the circuit, at least a portion of the first conductors and at least a portion of the second conductors are exposed outside the circuit on a first side of the circuit for operative connection to the first and second conductors of a respective one of the twisted pair cables.

18. The system of claim 10, wherein the first circuit conductors are spaced from the second circuit conductors in a thickness direction of the circuit, and wherein each first circuit conductor is substantially aligned with a respective one of the second circuit conductors in at least a first end portion of the circuit.

19. A method of forming a transducer assembly comprising the steps of:
providing an electrode subassembly including a piezoelectric base partially covered by a plating wrapped therearound, two substantially parallel deactivation cuts being formed in a surface of the plating so as to define a positive electrode between the deactivation cuts and a ground electrode outside of the two deactivation cuts;
forming a plurality of elongated cuts through the electrode subassembly such that a plurality of transducer elements is formed, each transducer element having a ground electrode and a positive electrode, the cuts extending generally transverse to the deactivation cuts;
providing a plurality of twisted pair cables, each twisted pair cable including a first cable conductor and a second cable conductor twisted about each other along at least a portion of their length;
operatively connecting each of the plurality of first cable conductors to the ground electrode of a respective one of the transducer elements; and
operatively connecting each of the plurality of second cable conductors to the positive conductor of a respective one of the transducer elements.

20. The method of claim 19, wherein the steps of operatively connecting the first and second cable conductors to the ground and positive electrodes of respective transducer elements includes the steps of:
providing a circuit including a plurality of first circuit conductors and a plurality of second circuit conductors, and
operatively connecting the circuit between the plurality of twisted pair cables and the plurality of transducers such that each first circuit conductor indirectly connects one of the first cable conductors to the ground electrode of a respective one of the transducer elements and such that each second circuit conductor indirectly connects one of the second cable conductors to the positive electrode of a respective one of the transducer elements.
